(19) United States
(12) Patent Application Publication
(10) Pub. No.: US 2017/0359593 A1
(43) Pub. Date: Dec. 14, 2017

(54) APPARATUS, METHOD AND COMPUTER PROGRAM FOR OBTAINING IMAGES FROM AN IMAGE CAPTURING DEVICE

(71) Applicant: Nokia Technologies Oy, Espoo (FI)

(72) Inventor: Krishna DUBBA, Bishops Stortford (GB)

(21) Appl. No.: 15/601,174

(22) Filed: May 22, 2017

(30) Foreign Application Priority Data
Jun. 8, 2016 (GB) 1609973.1

(51) Int. Cl. H04N 19/51; G06T 7/70; G06T 7/207; H04N 5/232

(52) U.S. Cl. CPC H04N 19/51; G06T 7/207; G06T 7/70; G06T 2207/10016; H04N 5/23254; G06T 2207/20021

(57) ABSTRACT

An apparatus, method and computer program wherein the apparatus comprises: processing circuitry; and memory circuitry including computer program code, the memory circuitry and the computer program code configured to, with the processing circuitry, enable the apparatus to; obtain images from an image capturing device; obtain measurements of movements of the image capturing device made while the images were captured; and use the obtained measurements of movements to calculate a sickness rating.

### TECHNOLOGICAL FIELD

Examples of the present disclosure relate to an apparatus, method and computer program for obtaining images from an image capturing device. In particular, they relate to an apparatus, method and computer program for obtaining images from an image capturing device where the obtained images are used in a virtual reality application.

### BACKGROUND

Virtual reality applications may enable a user to view captured images such that the captured images appear to be rendered in three dimensional space. This may replicate or augment a three dimensional environment.

When using such applications some users experience sickness. The sickness may comprise nausea, disorientation, headaches and other discomforts. Some users may be more sensitive than others to the sickness caused by virtual reality applications and other similar applications.

It is useful to provide apparatus and methods for providing applications such as virtual reality applications which may reduce the sickness experienced by the users.

### BRIEF SUMMARY

According to various, but not necessarily all, examples of the disclosure there is provided an apparatus comprising: processing circuitry; and memory circuitry including computer program code, the memory circuitry and the computer program code configured to, with the processing circuitry, enable the apparatus to; obtain images from an image capturing device; obtain measurements of movements of the image capturing device made while the images were captured; and use the obtained measurements of movements to calculate a sickness rating.

The memory circuitry and the computer program code may be configured to, with the processing circuitry, enable the apparatus to store information indicative of the calculated sickness rating with the obtained images.

The sickness rating may enable a rendering device to adjust the captured images when the captured images are being rendered.

The measurements of the movements of the image capturing device may be obtained from one or more sensors coupled to the image capturing device.

The measurements of the movements of the image capturing device may be obtained from at least one of; an accelerometer, a gyroscope, a network positioning system.

The obtained images may be used for a virtual reality application.

The sickness rating may be calculated based on the type of movements made by the image capturing device.

The sickness rating may be calculated based on the speed of the movements made by the image capturing device.

A local sickness rating may be assigned to a segment of images obtained by the image capturing device. A global sickness rating may be assigned to a plurality of segments of images obtained from the image capturing device. The global sickness rating may be calculated from a plurality of local sickness ratings.

According to various, but not necessarily all, examples of the disclosure there is provided an electronic device comprising an apparatus as claimed in any preceding claim.

According to various, but not necessarily all, examples of the disclosure there is provided a method comprising: obtaining images from an image capturing device; obtaining measurements of movements of the image capturing device made while the images were captured; and using the obtained measurements of movements to calculate a sickness rating.

The method may comprise storing information indicative of the calculated sickness rating with the obtained images.

The stored sickness rating may enable a rendering device to adjust the captured images when the captured images are being rendered.

The measurements of the movements of the image capturing device may be obtained from one or more sensors coupled to the image capturing device.

The measurements of the movements of the image capturing device may be obtained from at least one of; an accelerometer, a gyroscope, a network positioning system.

The obtained images may be used for a virtual reality application.

The sickness rating may be calculated based on the type of movements of the image capturing device.

The sickness rating may be calculated based on the speed of the movements of the image capturing device. A local sickness rating is assigned to a segment of images obtained by the image capturing device. A global sickness rating is assigned to a plurality of segments of images obtained from the image capturing device. The global sickness rating is calculated from a plurality of local sickness ratings.

According to various, but not necessarily all, examples of the disclosure there is provided a computer program comprising computer program instructions that, when executed by processing circuitry, enable: obtaining images from an image capturing device; obtaining measurements of movements of the image capturing device made while the images were captured; and using the obtained measurements of movements to calculate a sickness rating.

According to various, but not necessarily all, examples of the disclosure there is provided a computer program comprising program instructions for causing a computer to perform any of the methods described above.

According to various, but not necessarily all, examples of the disclosure there is provided a physical entity embodying the computer program as described above.

According to various, but not necessarily all, examples of the disclosure there is provided an electromagnetic carrier signal carrying the computer program as described above.

According to various, but not necessarily all, examples of the disclosure there is provided an apparatus comprising: means for obtaining images from an image capturing device; means for obtaining measurements of movements of the image capturing device made while the images were captured; and means for using the obtained measurements of movements to calculate a sickness rating.

According to various, but not necessarily all, examples of the disclosure there is provided an apparatus as claimed in claim 28 comprising means for performing the methods as described above.

According to various, but not necessarily all, examples of the disclosure there may be provided examples as claimed in the appended claims.

### BRIEF DESCRIPTION

For a better understanding of various examples that are useful for understanding the detailed description, reference will now be made by way of example only to the accompanying drawings in which:

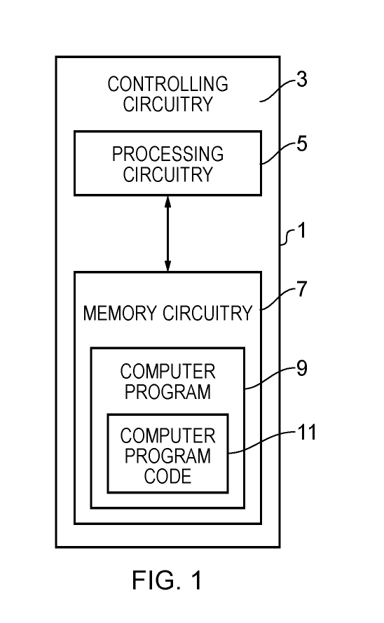

FIG. 1 illustrates an example apparatus;

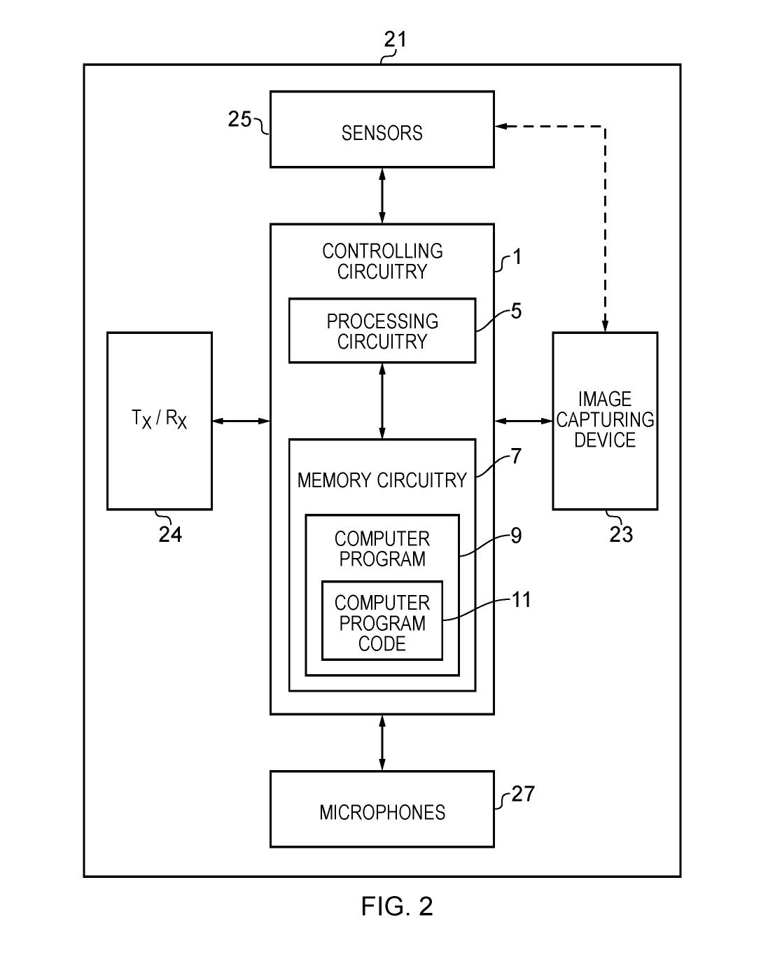

FIG. 2 illustrates an example electronic device;

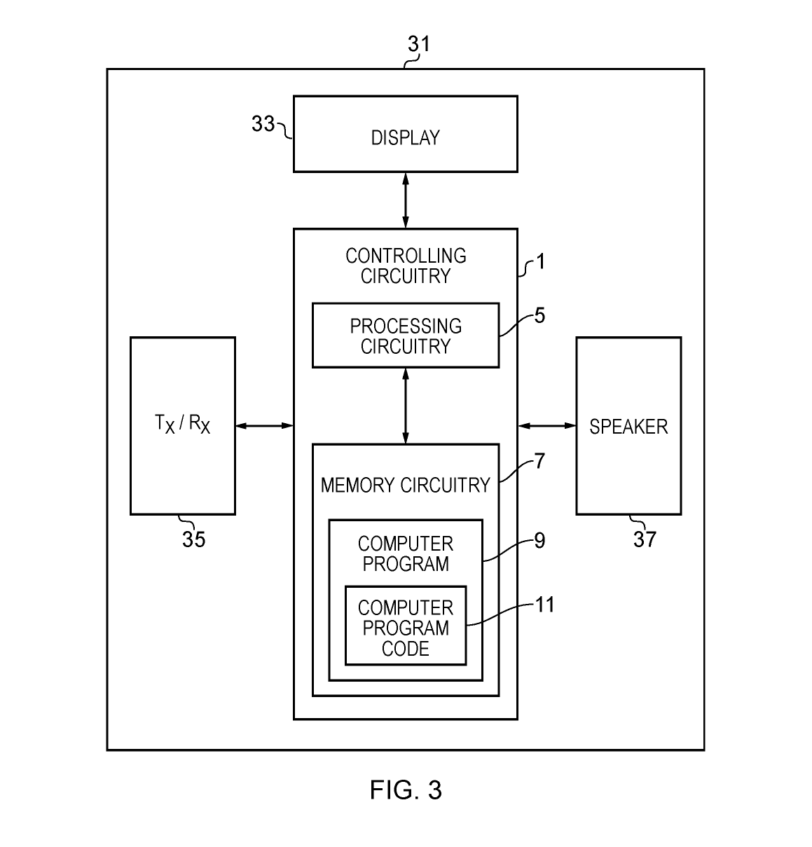

FIG. 3 illustrates an example electronic device for rendering obtained images;

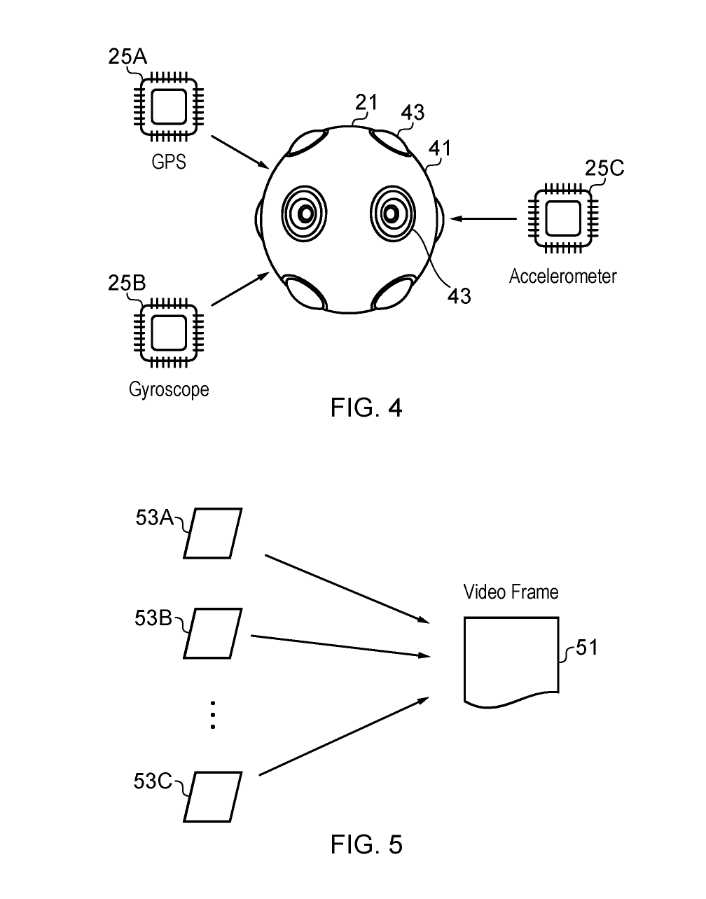

FIG. 4 illustrates an example electronic device;

FIG. 5 illustrates an example video frame;

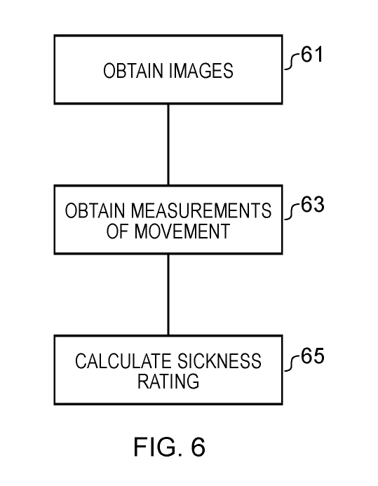

FIG. 6 illustrates an example method; and

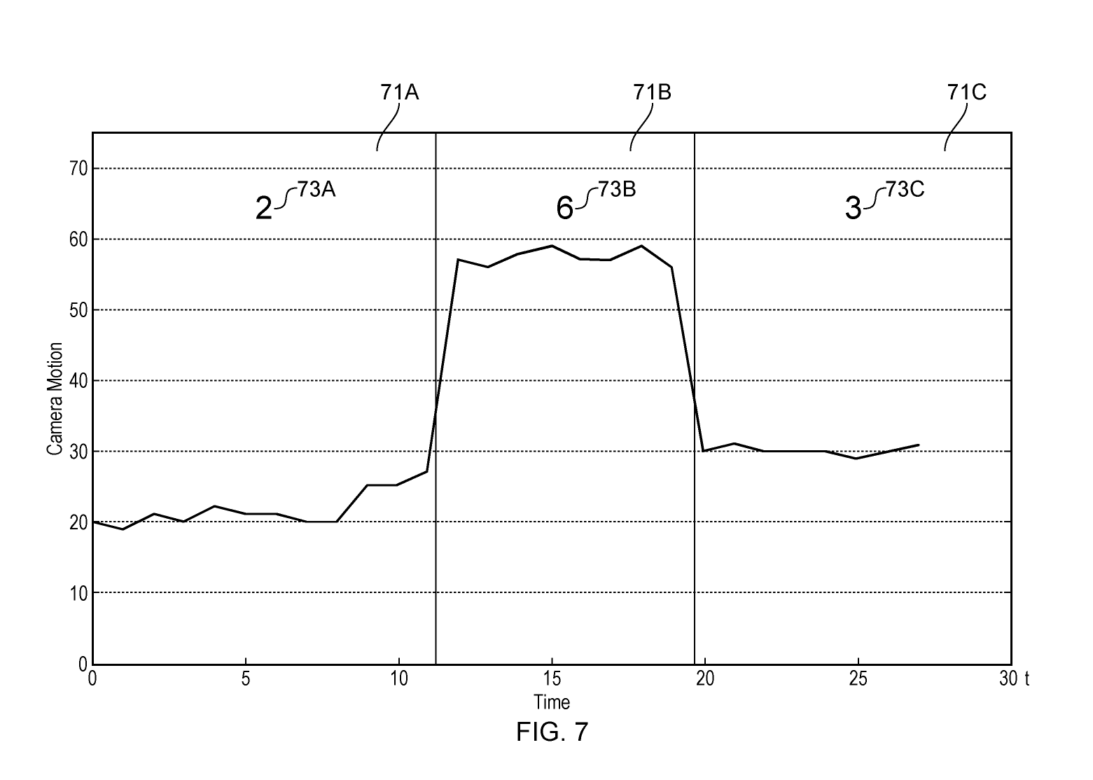

FIG. 7 illustrates an example sickness rating.

### DETAILED DESCRIPTION

The Figures illustrate an apparatus 1 comprising: processing circuitry 5; and memory circuitry 7 including computer program code 11, the memory circuitry 7 and the computer program code 11 configured to, with the processing circuitry 5, enable the apparatus 1 to; obtain 61 images from an image capturing device 23; obtain 63 measurements of movements of the image capturing device 23 made while the images were captured; and use 65 the obtained measurements of movements to calculate a sickness rating.

The apparatus 1 may be for capturing images for use in applications such as virtual reality or augmented reality applications. In some examples the apparatus 1 may be for processing captured images for use in applications such as virtual reality or augmented reality applications. In such examples the images may be captured by a separate image capturing device and provided to the apparatus 1 for processing. The rendering of the images may be controlled by the apparatus 1. In some examples the images may be provided to another electronic device for rendering.

FIG. 1 schematically illustrates an example apparatus 1 which may be used in examples of the disclosure. The apparatus 1 illustrated in FIG. 1 may be a chip or a chip-set. In some examples the apparatus 1 may be provided within an electronic device 21. The electronic device 21 could be a camera, a computer or any other suitable type of electronic device. Examples of an electronic device 21 are shown in FIG. 2.

The example apparatus 1 comprises controlling circuitry 3. The controlling circuitry 3 may provide means for controlling an electronic device 21. The controlling circuitry 3 may also provide means for performing the methods or at least part of the methods of examples of the disclosure.

The processing circuitry 5 may be configured to read from and write to memory circuitry 7. The processing circuitry 5 may comprise one or more processors. The processing circuitry 5 may also comprise an output interface via which data and/or commands are output by the processing circuitry 5 and an input interface via which data and/or commands are input to the processing circuitry 5.

The memory circuitry 7 may be configured to store a computer program 9 comprising computer program instructions (computer program code 11) that controls the operation of the apparatus 1 when loaded into processing circuitry 5. The computer program instructions, of the computer program 9, provide the logic and routines that enable the apparatus 1 to perform the example methods illustrated in FIG. 6. The processing circuitry 5 by reading the memory circuitry 7 is able to load and execute the computer program 9.

In some examples the computer program 9 may comprise a sickness rating application. The sickness rating application may be configured to use measurements of movements of an image capturing device 23 to calculate a sickness rating of a sequence of images captured by the image capturing device 23. The apparatus 1 therefore comprises: processing circuitry 5; and memory circuitry 7 including computer program code 11, the memory circuitry 7 and computer program code 11 configured to, with the processing circuitry 5, cause the apparatus 1 at least to perform: obtaining 61 images from an image capturing device 23; obtaining 63 measurements of movements of the image capturing device 23 made while the images were captured; and using 65 the obtained measurements of movements to calculate a sickness rating.

The computer program 9 may arrive at the apparatus 1 via any suitable delivery mechanism. The delivery mechanism may be, for example, a non-transitory computer-readable storage medium, a computer program product, a memory device, a record medium such as a compact disc read-only memory (CD-ROM) or digital versatile disc (DVD), or an article of manufacture that tangibly embodies the computer program. The delivery mechanism may be a signal configured to reliably transfer the computer program 9. The apparatus may propagate or transmit the computer program 9 as a computer data signal. In some examples the computer program code 11 may be transmitted to the apparatus 1 using a wireless protocol such as Bluetooth, Bluetooth Low Energy, Bluetooth Smart, 6LoWPan (IPᵥ6 over low power personal area networks) ZigBee, ANT+, near field communication (NFC), Radio frequency identification, wireless local area network (wireless LAN) or any other suitable protocol.

Although the memory circuitry 7 is illustrated as a single component in the figures it is to be appreciated that it may be implemented as one or more separate components some or all of which may be integrated/removable and/or may provide permanent/semi-permanent/dynamic/cached storage.

Although the processing circuitry 5 is illustrated as a single component in the figures it is to be appreciated that it may be implemented as one or more separate components some or all of which may be integrated/removable.

References to “computer-readable storage medium”, “computer program product”, “tangibly embodied computer program” etc. or a “controller”, “computer”, “processor” etc. should be understood to encompass not only computers having different architectures such as single/multi-processor architectures, Reduced Instruction Set Computing (RISC) and sequential (Von Neumann)/parallel architectures but also specialized circuits such as field-programmable gate arrays (FPGA), application-specific integrated circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term “circuitry” refers to all of the following:
(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

FIG. 2 schematically illustrates an example electronic device 21. The example electronic device 21 of FIG. 2 may be configured to enable images to be captured. The electronic device 21 may enable images to be captured for use in applications such as virtual reality or augmented reality applications. The electronic device 21 could be a camera or any other suitable device.

The electronic device 21 comprises an apparatus 1 as described above. Corresponding reference numerals are used for corresponding features. In addition to the apparatus 1 the example electronic device 21 of FIG. 2 also comprises an image capturing device 23 and one or more sensors 25. In some examples the electronic device 21 may also comprise one or more microphones 27 and one or more transceivers 29. It is to be appreciated that the electronic device 21 may comprise other features which are not illustrated in FIG. 2 such as, a power source, a user interface or any other suitable features.

The image capturing device 23 may comprise one or more cameras. The cameras may comprise any means which may be arranged to capture images. The cameras may comprise image sensors arranged to convert light incident on the image sensor into an electrical signal to enable an image to be produced. The image sensors may comprise any suitable type of image sensors such as digital image sensors such as charge-coupled-devices (CCD) or complementary metal-oxide-semiconductors (CMOS). The images which are obtained by the cameras may provide a representation of a scene and/or objects which are positioned in front of the one or more cameras.

The image capturing device 23 may comprise a plurality of cameras. The plurality of cameras may be spatially arranged within the electronic device 21 so as to enable three dimensional images to be captured. The plurality of cameras may be spatially arranged within the electronic device 21 to enable images to be obtained of different views. The different views may comprise different areas of space around the image capturing device 23. In some examples the cameras may be spatially arranged within the electronic device 21 to enable panoramic images to be obtained. The panoramic images may comprise 360° panoramic views or substantially 360° views.

The image capturing device 23 may be arranged to capture video images. The video images may be captured for a duration of time rather than for an instantaneous moment. While the video images are being captured the image capturing device 23 or parts of the image capturing device 23 may be moved.

The image capturing device 23 may be coupled to the apparatus 1 so that electrical signals comprising captured image information may be provided to the apparatus 1. The apparatus 1 may be configured to perform image processing on the captured image information. The apparatus 1 may be configured to calculate sickness ratings for the images captured by the image capturing device 23.

The electronic device 21 also comprises one or more sensors 25. The one or more sensors may comprise any suitable types of sensors which may be arranged to detect movement of the image capturing device 23, or at least part of the image capturing device 23. The sensors 25 may be arranged to make measurements of the movement of the image capturing device 23 while images are being captured.

The sensors 25 may be coupled to the image capturing device 23 to enable the sensors 25 to detect movement of the image capturing device 23 or parts of the image capturing device 23. In some examples the sensors 25 may be mounted on the image capturing device 23 so that the sensors 25 move as the image capturing device 23, or parts of the image capturing device 23 move.

The sensors 25 may comprise any means which enable movement of the image capturing device 23, or at least part or of the image capturing device 23, to be measured. In some examples the sensors 25 may comprise means for detecting accelerations of the image capturing device 23. For instance a gyroscope and/or accelerometer or any other suitable type of sensor may be arranged to detect accelerations of the image capturing device 23.

In some examples the sensors 25 may comprise positioning sensors. For examples the sensors 25 may comprise a global positioning system (GPS) chip or any other suitable positioning means. In some examples a local positioning system such as high accuracy indoor positioning (HAIP), motion capture (MoCap) or any other suitable local positioning system may be used. The positioning sensors 25 may be used to obtain information indicating how the position of the imaging device 23 changes.

The sensors 25 may be arranged to detect movements in three dimensions. For examples the sensors 25 may be able to detect movement of the image capturing device 23 in a horizontal and a vertical plane.

The sensors 25 may be coupled to the apparatus 1 so that electrical signals comprising measurements of movements of the image capturing device 23 may be provided to the apparatus 1. The apparatus 1 may be configured to process the measurements obtained from the sensors 25. In some examples the apparatus 1 may be configured to process the measurements obtained from the sensors to determine a type of movement of the image capturing device 23. For instance, the apparatus 1 may be arranged to analyse the measurements obtained from the sensors 25 to identify whether there is rotational movement, translational movement, vibrational movements, sudden accelerations or decelerations or any other types of movements. In some examples the apparatus 1 may also be arranged to determine other parameters of the movement of the image capturing device 23. For instance the apparatus 1 may be arranged to determine the speed at which the movements are made, the magnitude of the movements, the frequency of the movements or any other suitable parameters.

In some examples the sensors 25 may comprise one or more transceivers which may enable the position of the image capturing device to be tracked. For instance the sensors 25 may comprise transceivers which enable wireless communications, such as Bluetooth, to enable HAIP or MoCap positioning.

The apparatus 1 may also be arranged to analyse the measurements obtained from the sensors 25 to calculate a sickness rating for the images captured by the image capturing device 23. In some examples the apparatus 1 may use the identified types of movements and/or other parameters to calculate the sickness rating.

The apparatus 1 may be arranged so that, once the sickness rating has been calculated information indicative of the sickness rating is stored in the memory circuitry 7. The information indicative of the sickness rating is assigned as metadata to the captured images so that the sickness rating is associated with the captured images corresponding to the calculated sickness rating.

In some examples the electronic device 21 may also comprise one or more microphones 27. The microphones 27 may comprise any means which enable an audio signal 41 to be detected. The microphones 27 may comprise any means which may be configured to convert an input audio signal to an electrical output signal. The microphones 27 may be arranged to detect an audio signal at the same time as the image capturing device 23 is capturing images. The detected audio signals may be used with the captured images in applications such as virtual reality or augmented reality applications.

The one or more transceivers 29 may comprise one or more transmitters and/or receivers. The one or more transceivers 29 may comprise any means which enables the electronic device 21 to establish a communication connection with another electronic device 31 and exchange information with the another electronic device 31. The communication connection may comprise a wireless connection. This may enable images captured by the image capturing device 23 to be provided to another electronic device 31. This may enable other electronic devices 21 to be used to render the image captured by the electronic device 31. The sickness rating calculated by the apparatus 1 may also be provided with the captured images.

In some examples the one or more transceivers 29 may enable the apparatus 1 to connect to a network such as a cellular network. In some examples the one or more transceivers 29 may enable the apparatus 1 to communicate in local area networks such as wireless local area networks, Bluetooth networks or any other suitable network.

FIG. 3 illustrates an example electronic device 31. The example electronic device 31 of FIG. 3 may be arranged to receive a signal comprising image information and enable the image information to be rendered for a user. The electronic device 31 of FIG. 3 may be arranged to receive the image information from an electronic device 21 comprising an image capturing device 23 such as the electronic device 21 of FIG. 2.

The electronic device 31 of FIG. 3 also comprises an apparatus 1 which may be as described above. Corresponding reference numerals are used for corresponding features. In addition to the apparatus 1 the example electronic device 31 of FIG. 3 also comprises a display 33, one or more speakers 37 and one or more transceivers 35. It is to be appreciated that the electronic device 31 may comprise other features which are not illustrated in FIG. 3 such as, a power source, a user interface or any other suitable features. The electronic device 31 may be a head set, a personal electronic device or any other suitable type of electronic device.

The one or more transceivers 35 may comprise one or more transmitters and/or receivers. The one or more transceivers 35 may comprise any means which enables the electronic device 31 to establish a communication connection with another electronic device, such as the electronic device 21 of FIG. 2, and exchange information with the electronic device 21. The communication connection may comprise a wireless connection. This may enable images captured by the image capturing device 23 to be provided to electronic device 31 for rendering.

In some examples the one or more transceivers 35 may enable the apparatus 1 to connect to a network such as a cellular network. In some examples the one or more transceivers 35 may enable the apparatus 1 to communicate in local area networks such as wireless local area networks, Bluetooth networks or any other suitable network.

The transceiver 35 may be coupled to the apparatus 1 to enable information received by the transceiver 35 to be stored in the memory circuitry 7 of the apparatus 1. This may enable information such as captured images and associated sickness ratings to be stored in the memory circuitry 7.

The electronic device 31 also comprises a display 33. The display 33 may comprise any means which enables information to be displayed to a user. The display 33 could comprise a near eye display in a virtual reality headset or any other suitable type of display.

The display 33 may be coupled to the apparatus 1 so that image information stored in the memory circuitry 7 may be retrieved from the memory circuitry 7 and provided to the display 33 for rendering. In some examples the sickness rating may also be retrieved from the memory circuitry 7. The sickness rating may be received from the electronic device 21 which captures the image. The sickness rating may be received with the captured images so that the sickness rating is associated with the captured images.

The sickness rating may be used to adjust the images being rendered. For instance if the sickness rating of a sequence of images is above a threshold specified by a user these images may be removed or adjusted to reduce the sickness rating below the specified threshold before the images are rendered by the display 33.

In some examples the electronic device 31 may also comprise one or more speakers 37. The one or more speakers 37 may comprise any means which may be configured to convert an electrical input signal to an acoustic output signal. The one or more speakers 37 may be positioned within the electronic device 31 so that, in use, the one or more speakers 37 are positioned adjacent to the ear of the user.

The one or more speakers 37 may be coupled to the apparatus 1 so that audio information stored in the memory circuitry 7 may be rendered using the one or more speakers 37. The audio information may comprise information which has been obtained by the microphones 27 of an electronic device 21 such as the electronic device of FIG. 2. The audio signal may be provided at the same time as the captured images are displayed on the display 33.

FIG. 4 illustrates an example electronic device 21 which may comprise an image capturing device 23. The example electronic device 21 could be as described above in relation to FIG. 2.

In the example of FIG. 4 the electronic device 21 comprises a spherical or substantially spherical housing 41. Components of the electronic device 21, such as the apparatus 1 may be located within the housing 41. It is to be appreciated that other shapes of housing may be used in other examples of the disclosure. The housing of the electronic device may be any suitable shape which enables the panoramic images to be obtained.

The electronic device 21 of FIG. 4 comprises a plurality of cameras 43. The plurality of cameras 43 are provided within the spherical housing 41. The plurality of cameras 43 may form an image capturing device 23 as described above. The spherical housing 41 may enable the cameras 43 to be positioned to enable images suitable for use in virtual reality applications to be obtained. The cameras 43 are distributed around the surface of the spherical housing 41 to enable three dimensional panoramic images to be obtained.

The electronic device 41 also comprises a plurality of sensors 25 for detecting movement of the electronic device 21. In the example of FIG. 4 the sensors 25 are shown external to the electronic device 41. It is to be appreciated that the sensors 25 could be located within the spherical housing 41 or on the surface of the spherical housing 41 or in any other suitable position.

In the example of FIG. 4 three sensors 25 are provided. It is to be appreciated that other numbers and/or types of sensors 25 may be used in other examples of the disclosure.

In the example of FIG. 4 the first sensor 25A comprises a GPS sensor. The GPS sensor 25A may be configured to detect the global position of the electronic device 21 and any changes in this position. The second sensor 25B comprises a gyroscope. The gyroscope 25B may be arranged to detect accelerations of the electronic device 21 such as shakings or vibrations or other suitable movements. The third senor 25C comprises an accelerometer. The accelerometer 25C may be arranged to detect changes in angular positions of the electronic device 21. The accelerometer 25C may enable rotation of the electronic device 21 to be measured.

It is to be appreciated that in some examples the electronic device 21 could comprise more than one gyroscope 25B and more than one accelerometer 25C. This may enable movements in different directions to be detected.

The sensors 25 may enable the type of movement of the electronic device 21 to be detected. For example the measurements obtained by the sensors 25 may be used to determine whether the electronic device 21, and the image capturing device 23 within the electronic device 21, is rotating or vibrating or moving linearly or any combination of these or any other suitable type of movements. The measurements obtained by the sensors 25 may also be used to determine other parameters of the movement. For instance it may be used to measure the speed, frequency, magnitude or any other suitable parameter.

FIG. 5 schematically illustrates an example video frame 51. The example video frame comprises image information that has been captured by an image capturing device 23. Measurement information 53 from the sensors 25 may be added to the video frame 51. The measurement information 53 may be added to the video frame 51 as metadata so that the measurement information 53 is associated with the video frame 51. The measurement information 53 may be obtained at the same time as the image information in the video frame 51 is captured.

In the example of FIG. 5 three items of measurement information 53 are obtained and added to the video frame 51. The first item of measurement information 53A comprises information obtained from a GPS sensor 25A, the second item of measurement information 53B may comprise information obtained from a gyroscope 25B and the third item of measurement information 53C may comprise information obtained from an accelerometer 25C. It is to be appreciated that other types of measurement information could be obtained and added to the video frame 51 in other examples of the disclosure.

It is to be appreciated that both images and measurements of the movement of the imaging device 23 may be captured continuously. This may enable each video frame in a segment of images to have measurement information associated with it. This may enable an apparatus 1 to determine the amount of movement made by the capturing device 23 while a segment of images is captured. The amount of movement may then be used to determine the sickness rating for the segment of images.

FIG. 6 illustrates an example method which may be implemented using the apparatus 1 and/or electronic device 21 as described above.

The method comprises, at block 61, obtaining images from an image capturing device 23. At block 63 the method comprises obtaining measurements of movements of the image capturing device 23 made while the images were captured; and, at block 65 the method comprises using the obtained measurements of movements to calculate a sickness rating.

In some examples of the disclosure the method may be performed by an apparatus 1 within the electronic device 21 which houses the image capturing device 23. This may ensure that the sickness rating is calculated by the same device which captures the images. In other examples the sickness rating could be calculated by a different apparatus 1. In such examples the electronic device 21 may be arranged to transmit the captured images and the measurements of the movements of the image capturing device to a remote processing device. The remote processing device may then use the obtained measurements to calculate the sickness rating.

FIG. 7 illustrates example sickness ratings 73 for different segments 71 of images.

FIG. 7 illustrates a plot of the amount of movement of the image capturing device 23 over a period of time while images are being captured. The x axis represents time t and the y axis represents the amount of motion of the image capturing device 23.

In the example of FIG. 7 this movement information was obtained using GPS sensor 25A. The numerical value of the amount of motion may correspond to the speed of the motion or any other suitable parameter. It is to be appreciated that other types sensor 25 could be used in other examples. In some examples information from a plurality of different sensors 25 may be combined to provide a numerical value.

In the example of FIG. 7 the images obtained are divided into three segments 71A, 71B and 71C. The three segments 71A, 71B and 71C comprise images that are captured at different times. In the example of FIG. 7 the three segments 71A, 71B and 71C run consecutively but do not overlap. In other examples different segments of images may overlap or at least partially overlap.

In the example of FIG. 7 the sickness rating 73 comprises a numerical value. The numerical value could be one of a limited range of values, for example a score out of ten where a high score indicates a high likelihood of causing sickness and a low score indicates a low likelihood of causing sickness. In other examples the sickness rating could be an absolute value or values obtained from the measurements of the movement of the image capturing device 23.

In the example of FIG. 7 each of the segments 71A, 71B and 71C has a different sickness rating 73. In the first segment 71A the image capturing device 23 was not moving very much. The GPS sensor 25A has only detected a small amount of movement for the first segment 71A. This results in a low first sickness rating 73A of 2. In the second segment 71B the image capturing device 23 starting moving a lot. This results in a higher second sickness rating 73B of 6. In the third segment 71C the amount of movement is reduced from the second segment 71B but is still higher than in the first segment 71A. This results in a third sickness rating 73A of 3.

The numerical value of the sickness rating 73 may be calculated from the measurements obtain from the sensors 25 using any suitable algorithm or process. hi the example of FIG. 7 the sickness ratings 73 may be calculated so that a higher numerical value corresponds to more movements and a higher likelihood that the segment 71 of images will make the user feel sick.

The numerical value of the sickness rating 73 may take into account different parameters of the movement of the imaging device 23. In the example of FIG. 7 the magnitude of the movements may be used to determine the sickness rating 73. In other examples other parameters may be used to determine the sickness ratings. For instance, in some examples the speed of the movements may be used. In some examples the type of the movements could be identified and used to calculate the sickness ratings. Some types of movement could be associated with higher sickness ratings than other types of movements. For instance, rotational movements, rocking movements and vibrational movements could be associated with higher sickness ratings. This could mean that slower rotational movements could be associated with a higher sickness rating than a faster linear motion.

The numerical value may be assigned to the segments 71 of images and stored in memory circuitry 7 with the segment 71 of images. The numerical value of the sickness rating may be assigned to the segment 71 of images as metadata. When the segment 71 of images is to be rendered by an electronic device 31 the numerical value of the sickness rating 73 may be used by the electronic device 31 to determine whether to adjust the images before they are rendered on the display 33. For instance if the user has specified that they are not comfortable with sickness ratings 73 above 5 then the electronic device 31 would determine that no adjustment is needed for the first segment or the or the third segment but that some adjustment is needed for the second segment 71B. The adjustment that is used for the second segment 71B could be removing images or modifying the images to reduce the amount of motion within the rendered images.

In the example of FIG. 7 the sickness ratings 73 may be classed as local sickness ratings because they assigned to segments 71 of images. In some examples a global sickness rating could be assigned to a plurality of the segments 71 of images. The global sickness rating may be calculated from the plurality of local sickness ratings. For instance, in some examples the global sickness rating may be calculated as the average or maximum or other function and/or combination of the local sickness ratings 71. The global sickness rating may be stored in the memory circuitry 7 with the captured images. The global sickness rating may be provided to a user before they select the images to be rendered. This may enable a user to use the global sickness rating to decide whether or not they wish to view the images.

Examples of the disclosure relate to an apparatus 1 which may be used to provide content such as virtual reality content which can be categorized and/or adapted to take into account whether or not the content may make the user feel sick. The user may use the sickness ratings to avoid content which make them feel sick. In some examples the rendering electronic device may use the sickness ratings to adapt the content to avoid making the user feel sick.

In examples of the disclosure the sickness ratings are obtained from measurements from sensors coupled to the image capturing device 23. This means that the sickness ratings can be obtained without having to obtain any measurements from the user. This ensures that the ratings are consistent as they are not subject to measurements from individual users. This avoids variations in how different users respond to virtual reality content. This also avoids users having to be subjected to content which makes them feel sick in order to obtain the measurements.

The sickness ratings can be obtained by using measurements obtained from sensors 25 coupled to the image capturing device 23. This means that only the image capturing device 23 needs to have any special sensors 25 or circuitry. The captured images and the calculated sickness ratings can then be transmitted to and rendered by any suitable device. There is no requirement for any further sensors or circuitry within the electronic device 31 which renders the images.

Furthermore, as the sickness ratings are calculated from the measurements obtained by the one or more sensors 25 the sickness ratings can be obtained without any heavy computation. This may ensure that calculating the sickness ratings does not provide an unnecessary burden on the processing capacity of an electronic device.

The term “comprise” is used in this document with an inclusive not an exclusive meaning. That is any reference to X comprising Y indicates that X may comprise only one Y or may comprise more than one Y. If it is intended to use “comprise” with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term “example” or “for example” or “may” in the text denotes, whether explicitly stated or not, that such features or functions are present in at least the described example, whether described as an example or not, and that they can be, but are not necessarily, present in some of or all other examples. Thus “example”, “for example” or “may” refers to a particular instance in a class of examples. A property of the instance can be a property of only that instance or a property of the class or a property of a sub-class of the class that includes some but not all of the instances in the class. It is therefore implicitly disclosed that a features described with reference to one example but not with reference to another example, can where possible be used in that other example but does not necessarily have to be used in that other example.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus comprising:
processing circuitry; and
memory circuitry including computer program code, the memory circuitry and the computer program code configured to, with the processing circuitry, enable the apparatus to;
obtain images from an image capturing device;
obtain measurements of movements of the image capturing device made while the images were captured; and
use the obtained measurements of movements to calculate a sickness rating.

2. The apparatus as claimed in claim 1 wherein the memory circuitry and the computer program code are configured to, with the processing circuitry, enable the apparatus to store information indicative of the calculated sickness rating with the obtained images.

3. The apparatus as claimed in claim 1 wherein the sickness rating enables a rendering device to adjust the captured images when the captured images are being rendered.

4. The apparatus as claimed in claim 1 wherein the measurements of the movements of the image capturing device are obtained from one or more sensors coupled to the image capturing device.

5. The apparatus as claimed in claim 1 wherein the measurements of the movements of the image capturing device are obtained from at least one of; an accelerometer, a gyroscope, a network positioning system.

6. The apparatus as claimed in claim 1 wherein the obtained images are used for a virtual reality application.

7. The apparatus as claimed in claim 1 wherein the sickness rating is calculated based on the type of movements made by the image capturing device.

8. The apparatus as claimed in claim 1 wherein the sickness rating is calculated based on the speed of the movements made by the image capturing device.

9. The apparatus as claimed in claim 1 wherein a local sickness rating is assigned to a segment of images obtained by the image capturing device.

10. The apparatus as claimed in claim 9 wherein a global sickness rating is assigned to a plurality of segments of images obtained from the image capturing device.

11. The apparatus as claimed in claim 10 wherein the global sickness rating is calculated from a plurality of local sickness ratings.

12. An electronic device comprising the apparatus as claimed in claim 1.

13. A method comprising:
obtaining images from an image capturing device;
obtaining measurements of movements of the image capturing device made while the images were captured; and
using the obtained measurements of movements to calculate a sickness rating.

14. The method as claimed in claim 13 comprising storing information indicative of the calculated sickness rating with the obtained images.

15. The method as claimed in claim 13 wherein the stored sickness rating enables a rendering device to adjust the captured images when the captured images are being rendered.

16. The method as claimed in claim 13 wherein the measurements of the movements of the image capturing device are obtained from one or more sensors coupled to the image capturing device.

17. The method as claimed in claim 13 wherein the measurements of the movements of the image capturing device are obtained from at least one of; an accelerometer, a gyroscope, a network positioning system.

18. The method as claimed in claim 13 wherein the obtained images are used for a virtual reality application.

19. The method as claimed in claim 13 wherein the sickness rating is calculated based on the type of movements of the image capturing device.

20. A computer program comprising computer program instructions that, when executed by processing circuitry, enable:
obtaining images from an image capturing device;
obtaining measurements of movements of the image capturing device made while the images were captured; and
using the obtained measurements of movements to calculate a sickness rating.
